(19) United States
(12) Patent Application Publication
(10) Pub. No.: US 2017/0087496 A1
(43) Pub. Date: Mar. 30, 2017

(54) Filter Medium and Use of the Filter Medium

(71) Applicant: MANN+HUMMEL GMBH, Ludwigsburg (DE)

(72) Inventors: Philipp Hettkamp, Freiberg (DE); Johannes Weber, Stuttgart (DE)

(21) Appl. No.: 15/279,550

(22) Filed: Sep. 29, 2016

(30) Foreign Application Priority Data
Sep. 30, 2015 (DE) 102015012643.1

(51) Int. Cl. B01D 46/00; B01D 39/16; B32B 5/26; B01D 39/20; B01D 39/14; B01D 39/18; B01D 46/52

(52) U.S. Cl. CPC B01D 46/0023; B01D 39/18; B01D 39/1623; B01D 46/521; B01D 39/2017; B01D 39/14; B32B 5/26; B01D 2275/10; B01D 2279/60; B01D 2239/064; B01D 2239/0654; B01D 2239/1258; B32B 2250/20; B32B 2262/0276; B32B 2262/062; B32B 2262/101; B32B 2307/724

(57) ABSTRACT

A filter medium has at least a first filter layer as a substrate layer and a second filter layer as a cover layer, wherein the cover layer is arranged at an inflow side relative to the substrate layer. The substrate layer contains a proportion of cellulose fibers of at least 60% relative to a total fiber contents of the substrate layer. The cover layer contains a proportion of polymeric synthetic fibers and/or mineral fibers of at least 20% relative to a total fiber contents of the cover layer. The substrate layer has a maximum thickness of 0.28 mm. The filter medium has a total air permeability according to ISO 9237 that amounts to more than 45 l/m³. The fibers of the cover layer have a packing density of 0.08 to 0.16 and the fibers of the substrate layer have a greater packing density than the fibers of the cover layer.

### BACKGROUND OF THE INVENTION

The invention concerns a filter medium, in particular for filtration of air, comprising at least a first filter layer as a substrate layer and a second filter layer as a cover layer arranged at the inflow side relative to the substrate layer, wherein the substrate layer comprises a proportion of cellulose fibers of at least 60% relative to the total fiber contents of this substrate layer, and wherein the cover layer comprises a proportion of polymeric synthetic fibers and/or mineral fibers of at least 20% relative to the total fiber contents of this cover layer. The invention further concerns use of this filter medium.

DE 10 2012 010 307 A1 discloses a filter medium for liquid filtration. This filter medium comprises a wet-laid nonwoven of cellulose fibers, synthetic fibers or inorganic fibers and a prefilter layer.

In case of cellulose-containing air filter media, a partial blocking of pores in a cellulose-containing substrate layer by dust contained in the air may occur in the initial phase of filtration. This blocking leads to an increased pressure rise.

Based on this prior art, it is now the object of the present invention to provide a filter medium which has a reduced tendency for blocking of the pores, is however at the same time comparatively thin, and exhibits a good filtration efficiency.

### SUMMARY OF THE INVENTION

The invention solves this object with a filter medium characterized in that the substrate layer has a maximum thickness of 0.28 mm, wherein the total air permeability of the filter medium according to ISO 9237 amounts to more than 45 l/m³, and wherein the fibers of the cover layer have a packing density of 0.08 to 0.16, and wherein the fibers of the substrate layer have a greater packing density than the fibers of the cover layer.

A filter medium according to the invention comprises at least a first filter layer as a substrate layer and a second filter layer as a cover layer which is arranged at the inflow side relative to the substrate layer.

The substrate layer comprises a proportion of cellulose fibers of at least 60% relative to the total fiber contents of this substrate layer.

The cover layer comprises a proportion of polymeric synthetic fibers and/or mineral fibers of at least 20% relative to the total fiber contents of this cover layer. These polymeric synthetic fibers and/or mineral fibers reduce the penetration of dust particles into the pores of the cellulose material of the substrate layer.

The substrate layer is embodied to be comparatively thin with a maximum thickness of 0.28 mm.

Total air permeability of the filter medium amounts to more than 45 l/(m³*s) at 200 Pa pressure difference (value according to ISO 9237 at the time of filing the priority application). The total air permeability is the air permeability of the filter medium and does not concern the air permeabilities of the respective individual layers of which the filter medium is constructed.

The fibers of the cover layer have a packing density of 0.08 to 0.16. This comparatively minimal packing density enables a good and blocking-reduced filtration without an excessive pressure rise being observed at the beginning of filtration. The cover layer can optionally be provided also as a prefilter layer.

The fibers of the substrate layer comprise a greater packing density than the fibers of the cover layer. As a whole, the substrate layer is to be understood as a main filter layer.

Advantageous embodiments of the invention are subject matter of the dependent claims.

The filter medium can advantageously exhibit a gravimetric filtration efficiency n₅ at 5 mbar pressure rise of equal to or greater than 99.85%.

Advantageously, the substrate layer can have a thickness of 0.15 mm to 0.25 mm. This is particularly beneficial, for example, when used in a folded bellows because, as a result of the minimal thickness, an especially large number of folds and therefore a large filtration surface area can be achieved.

Advantageously, the cover layer of the filter medium can have a thickness of 0.1 mm to 0.2 mm. Accordingly, in particular larger dust particles can be caught and can be filtered out before impacting on the substrate layer.

The filter medium can be constructed advantageously of two layers and thus can be comprised only of the substrate layer and the cover layer. Accordingly, the filter medium can be realized inexpensively and in a particular thin embodiment variant.

The synthetic and/or mineral fibers can have a mean fiber diameter of 5 μm-20 μm so that they contribute with their high mechanical resistance to an advantageous open structure of the cover layer and at the same time exhibit excellent filtration properties.

It is advantageous when the air permeability of the filter medium amounts to 50 l/m³ to 200 l/m³ and/or when the filter medium has a total height or a thickness of less than 0.35 mm.

The cover layer can be comprised of a mixture of cellulose fibers and polymeric synthetic fibers and/or mineral fibers wherein the polymeric synthetic fibers and/or mineral fibers are contained in a proportion of up to 60% relative to the total fiber contents.

The cover layer can advantageously have a fiber contents of cellulose fibers relative to the total fiber contents of the cover layer which is at least 25%, preferably at least 35%, less than the fiber contents of cellulose fibers relative to the total fiber contents of the substrate layer.

Due to its relatively minimal thickness, the filter medium can be used particularly well in a filter element in folded form. The filter medium can have very many folds so that a high surface area for filtration is provided.

The filter medium can be used in accordance with the invention for filtration of intake air of internal combustion engines and/or gas turbines.

### BRIEF DESCRIPTION OF THE DRAWINGS

In the following the invention will be explained by means of an embodiment with the aid of the attached Figures in more detail in an exemplary fashion.

FIG. 1 shows a schematic illustration of a filter medium according to the invention.

FIGS. 2a and 2b are schematic illustrations of filter elements according to the invention.

FIG. 3 shows a graph illustrating on the x-axis the dirt holding capacity also referred to as DHC (dust holding capacity) plotted against the pressure difference on the y-axis.

The Figures show only examples and are not to be understood as limiting.

### DESCRIPTION OF PREFERRED EMBODIMENTS

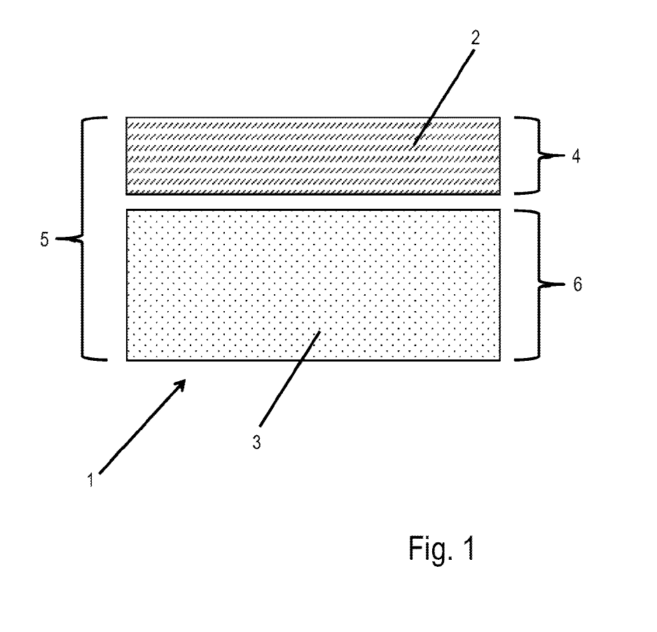

FIG. 1 shows an embodiment of a filter medium 1 according to the invention with a substrate layer 2 that is embodied as a first fiber layer in the form of a cellulose fiber layer and with at least one cover layer 3 which is arranged at the inflow side on the substrate layer and is embodied as a second fiber layer. The cover layer 3 preferably can comprise a fiber contents of cellulose fibers which relative to the substrate layer is reduced by at least 25%. Particularly preferred, the fiber contents of cellulose fibers relative to the total fiber contents of the cover layer 3 is reduced by 35% in comparison to the fiber contents of cellulose fibers relative to the total fiber contents of the substrate layer 2. However, the cover layer 3 can also be completely formed of non-cellulose fibers.

The substrate layer 2 is preferably embodied as a fine-pore cellulose fiber-containing paper. It exhibits a compressed structure of fibers and fiber interstices which are referred to as pores in the context of the present invention. This substrate layer 2 can preferably have a fiber contents of cellulose fibers which amounts to at least 60%, preferably at least 70%, relative to a total contents of fibers in the substrate layer.

In a first embodiment variant, the substrate layer 2 can be formed completely of cellulose fibers.

In a second embodiment variant, the substrate layer 2 can be comprised of a mixture of cellulose fibers with synthetic and/or mineral fibers.

The substrate layer 2 is embodied to be comparatively thin. It can have a preferred thickness 6 of 0.15 mm-0.25 mm. Functionally, the substrate layer enables the main filtration of dust-laden air, dust holding and/or the retention of dust.

The cover layer 3 serves for protecting the cellulose-containing filter layer underneath against blocking of the pores. The fibers of the second fiber layer comprise at least a fiber contents of 20% of glass fibers and/or polymeric synthetic fibers. Preferred polymeric synthetic fibers are in particular polyester fibers. They are, like glass fibers, stiffer than cellulose fibers so that a higher stiffness and thus a greater porosity of the cover layer are achieved.

The mean diameter of the glass fibers and/or polymeric synthetic fibers of this second fiber layer or the cover layer 3 is preferably between 5 μm to 20 μm. At the inflow side, the fibers can be applied of only one type or as a mixture with cellulose fibers.

The proportion of fibers relative to the total fiber contents can be between 20% and 60%.

The thickness 4 of the cover layer 3 is 0.1 mm to 0.2 mm. The air permeability of the cover layer 3 is greater than that of the substrate layer 2. In contrast to this, the packing density of the substrate layer 2 is higher than that of the cover layer 3. In this context, the cover layer 3 comprises a packing density of 0.08 to 0.16.

In a preferred embodiment variant, the preferred packing density of the substrate layer 2 is greater than 0.2.

A fiber of the cover layer 3 comprises a fiber length axis. Through this fiber length axis, a plurality of lines of intersection are extending perpendicular to the fiber length axis on a fiber cross-section and all extend through the fiber length axis. In a preferred embodiment variant of the invention, the line of intersection with the smallest length is maximally 70% smaller than the line of intersection having the greatest length. This shows that the fiber cross-section ideally is not flat but more or less has the shape of a circular surface.

The filter medium can however also have more than two fiber layers. For example, also at the outflow side relative to the substrate layer a third fiber layer can be arranged. It can be configured in analogy to the second fiber layer.

On the second and/or third fiber layer, additionally a nanofiber layer can be arranged. Preferably, at least 90% of the fibers of this fiber layer are nanofibers. A nanofiber is a fiber with a mean fiber diameter between 1 nanometer and 1,000 nanometers.

The filter medium optionally can also have further material layers, for example, impact protection meshes or filter layers. In a preferred embodiment variant, the filter medium is however of a two-layer configuration.

The fiber diameter of the fibers can be determined with the aid of an image section. In this context, the fiber diameters of all fibers contained in the image section can be determined and an average value of these fibers can be determined. Particularly preferred, the mean fiber diameter is determined by a method as it is described in U.S. Ser. No. 12/889,447 filed 24 Sep. 2010 (corresponding to DE 10 2009 043 273 A1), U.S. Ser. No. 12/889,447 is incorporated by reference in the present patent application in its entirety.

The material thickness can be determined with a measuring device for determining the thickness according to standard ISO 534 (at a pressure of 10 kPa).

The packing density can be determined according to a method disclosed in detail in U.S. Ser. No. 14/922,063 filed 23 Oct. 2015 (corresponding to DE 10 2013 008 391 A1), using synthetic resin for embedding, wherein U.S. Ser. No. 14/922,063 is incorporated by reference in the present application in its entirety.

The manufacture of the filter medium 1 can be carried out according to the wet-laid method so that, for example, in contrast to the meltblown method, thin and defined filter layers can be realized particularly well.

In a first step, providing of the substrate layer by headbox distribution of a cellulose-containing mixture is carried out.

In a second step, the application of the second fiber layer as a cover layer 3 on the substrate layer 2 by headbox distribution can be realized.

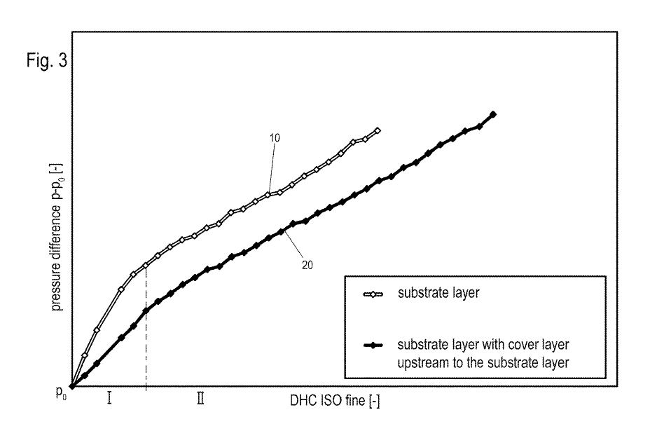

FIG. 3 shows on the x-axis a dirt holding capacity also referred to as DHC=dust holding capacity. The latter correlates with a pressure difference beginning at an initial value p₀ which is shown on the y-axis. This dirt holding capacity was measured on the basis of ISO 5011 on the flat round blank. As dust, dust type A2 fine according to ISO 12 103-1 was used. The specific surface area was 4,000 cm²/m³/min, the dust concentration 1,000 mg/m³. A preferred gravimetric filtration efficiency after 5 mbar pressure rise of η≧99.85% was found for the filter medium according to the invention.

The measured curve 10 describes in this context a single-layer filter medium with a pure cellulose-containing substrate layer. The measured curve 20 describes in contrast thereto a two-layer filter medium in which the substrate layer which was also used in curve 10 was provided with an appropriate cover layer at the inflow side relative to the substrate layer so that a filter medium according to the invention is provided.

As can be seen in FIG. 3, the dirt holding capacity of the filter medium according to the invention upon reaching the highest pressure difference relative to the dirt capacity of a pure substrate layer is significantly higher. The maximum dirt holding capacity at the same pressure difference relative to an initial pressure is therefore at least 10% higher for the filter medium according to the invention than in a single-layer filter medium with a pure substrate layer for a comparable material thickness relative to the substrate layer 2 of a filter medium 1 according to the invention without the cover layer 3 at the inflow side.

By arranging the second filter layer 3 on the substrate layer 2, blocking of the substrate layer can be prevented. This effect which is occurring in almost all thin cellulosic media is illustrated in FIG. 3.

These differences can be explained in that blocking of individual surface areas of the filter medium with dust is effectively prevented by providing the cover layer 3 and a uniform dust layer can form on the filter medium.

The blocking danger for cellulose-based filter media occurs primarily during the first time of dust loading. In this situation, dust particles penetrate at certain locations, for example, in a large-pore area, deep into the filter medium and block thereat the filter pores of the medium. Due to the blocked pores, the pressure rise is higher than for uniform dust loading at the surface. In curve 10, one can see a pressure jump in the area I. Only after a uniform dust layer has been built, a significantly smaller pressure rise can be observed which is extending almost parallel to the curve 20 of the filter medium according to the invention. This can be seen in FIG. 3 in the area II.

Due to the reduced packing density of the cover layer 3 at the inflow side, the solid particle proportion on the surface of the cellulosic substrate layer 2 is reduced. Accordingly, a more uniform dust layer can be built.

The total thickness 5 of the filter medium 1 is preferably maximally 0.35 mm. The total packing density of the filter medium 1 is preferably 0.2 to 0.4.

The preferred thickness of the cover layer 3 corresponds in a preferred embodiment of the invention to at least 30% of the thickness of the substrate layer.

The air permeability of the filter medium according to ISO 9327 at a pressure loss across the medium of 200 Pa amounts to more than 45 I per square meter per second of the filter medium. The preferred air permeability of the filter medium 1 is from 50 liter per square meter per second to 200 liter per square meter per second and, particularly preferred, 80 liter per square meter per second to 150 liter per square meter per second.

The filter medium is suitable in particular for air filtration. Preferably, the filter medium can be used in intake air filters of internal combustion engines and gas turbines. Particularly preferred are uses for heavier freight vehicles, for example, trucks, and construction machinery.

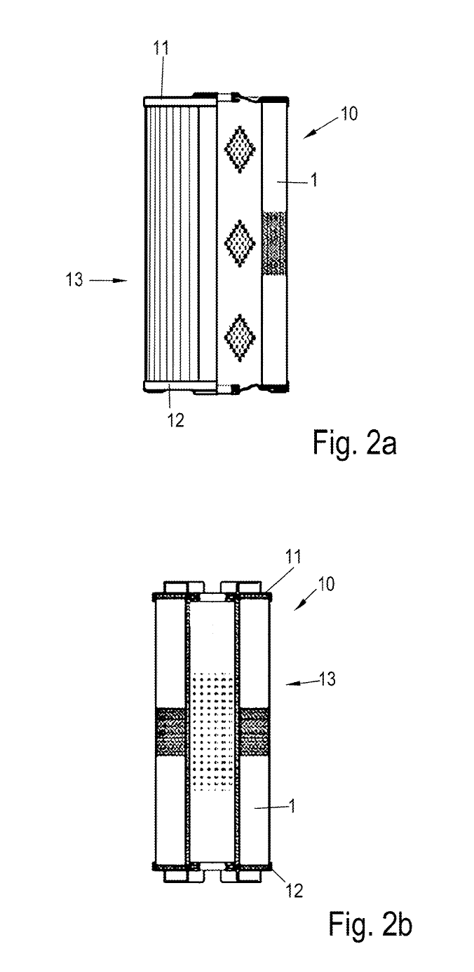

FIGS. 2a and 2b show different variants of a filter element 10 with a pleated filter medium 1 according to the embodiment of FIG. 1. The filter medium 1 is pleated to a star shape and folded to a round body which at both ends is closed off by a first end disk 11 and a second end disk 12. These two end discs 11, 12 serve for reception and fixation as well as sealing of the filter element 10 in a housing of a filter system. Fold edges can be seen on the outer circumference of the round body of the filter medium 1. The flow-through direction 13 of the filter element 10 with a fluid is in radial direction from the exterior into the round body of the filter medium 1 to the interior where the filtered medium, preferably a gaseous medium, in particular air, can then be discharged again axially out of the filter element 10 through an outlet.

While specific embodiments of the invention have been shown and described in detail to illustrate the inventive principles, it will be understood that the invention may be embodied otherwise without departing from such principles.

What is claimed is:

1. A filter medium comprising:
at least a first filter layer as a substrate layer and a second filter layer as a cover layer, wherein the cover layer is arranged at an inflow side relative to the substrate layer;
wherein the substrate layer comprises fibers including a proportion of cellulose fibers of at least 60% relative to a total fiber contents of the substrate layer;
wherein the cover layer comprises fibers including a proportion of polymeric synthetic fibers and/or mineral fibers of at least 20% relative to a total fiber contents of the cover layer;
wherein the substrate layer has a maximum thickness of 0.28 mm;
wherein the filter medium has a total air permeability according to ISO 9237 that amounts to more than 45 l/m³;
wherein the fibers of the cover layer have a packing density of 0.08 to 0.16 and the fibers of the substrate layer have a greater packing density than the fibers of the cover layer.

2. The filter medium according to claim 1, comprising a gravimetric filtration efficiency η after 5 mbar pressure rise of equal to or greater than 99.85%.

3. The filter medium according to claim 1, wherein the substrate layer has a thickness according to ISO 534 of 0.15 mm to 0.25 mm.

4. The filter medium according to claim 1, wherein the cover layer has a thickness according to ISO 534 of 0.1 mm to 0.2 mm.

5. The filter medium according to claim 1, having a two-layer configuration.

6. The filter medium according to claim 1, wherein the synthetic fibers and/or the mineral fibers of the cover layer have a mean fiber diameter of 5 μm-20 μm.

7. The filter medium according to claim 1, wherein the total air permeability according to ISO 9237 amounts to 50 l/m³ to 200 l/m³.

8. The filter medium according to claim 1, wherein the total air permeability according to ISO 9237 amounts to 80 l/m³ to 150l/m³.

9. The filter medium according to claim 1, having a total height according to ISO 534 of less than 0.35 mm.

10. The filter medium according to claim 1, wherein the fibers of the cover layer are a mixture of cellulose fibers and of the polymeric synthetic fibers and/or the mineral fibers, wherein the polymeric synthetic fibers and/or the mineral fibers are contained in a proportion of up to 60% relative to the total fiber contents of the cover layer.

11. The filter medium according to claim 1, wherein the cover layer has a fiber contents of cellulose fibers relative to the total fiber contents of the cover layer which is at least 25% less than the fiber contents of cellulose fibers relative to the total fiber contents of the substrate layer.

12. The filter medium according to claim 11, wherein the fiber contents of cellulose fibers of the cover layer relative to the total fiber contents of the cover layer is at least 35% less than the fiber contents of cellulose fibers relative to the total fiber contents of the substrate layer.

13. The filter medium according to claim 1 for filtration of intake air of an internal combustion engine or a gas turbine.

14. A filter element comprising a filter medium according to claim 1, wherein the filter medium is arranged as a folded bellows.
